(19) United States
(12) Patent Application Publication
(10) Pub. No.: US 2010/0214352 A1
(43) Pub. Date: Aug. 26, 2010

(54) INK FOR INKJET TEXTILE PRINTING

(75) Inventors: Hajime Tsunoda, Ibaraki-ken (JP); Hiroyuki Ogawa, Ibaraki-ken (JP); Kazuhiro Higashi, Ibaraki-ken (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/682,475

(22) PCT Filed: Sep. 30, 2008
(86) PCT No.: PCT/JP2008/067719

§ 371 Date: Apr. 9, 2010

(30) Foreign Application Priority Data
Oct. 18, 2007 (JP) 2007-271240

(51) Int. Cl. B41J 2/015

(52) U.S. Cl. 347/21; 524/386

(57) ABSTRACT

An ink for inkjet textile printing comprising a pigment, a water-dispersible resin, water, and a water-soluble organic solvent, wherein the water-soluble organic solvent comprises a polyol having an SP value within a range from 10 to 15.5 (cal/cm³)^{1/2}, and the water-dispersible resin comprises a urethane resin having a glass transition point within a range from −35 to 10° C.

### TECHNICAL FIELD

The present invention relates to an ink for inkjet textile printing that can be used for textile printing using an inkjet recording method, and also relates to a method for producing a printed textile item that uses the ink.

### BACKGROUND ART

Examples of methods that may be used for printing images such as text, pictures or designs onto fabrics such as woven fabrics and nonwoven fabrics include screen printing methods and roller printing methods, but more recently, inkjet textile printing methods, in which image processing is conducted using a computer and the image can then be printed essentially without a plate or screen, are attracting considerable attention.

Inkjet textile printing methods include transfer methods in which following printing onto a transfer sheet, the image is transferred to the fabric by thermal transfer, iron printing methods in which following printing to a heat-fixable resin film (an iron printing sheet), the resin film is subjected to heat fixing, and direct printing methods in which printing is conducted directly onto the fabric.

Of these methods, direct printing methods, which require no secondary materials such as the transfer sheet required in transfer methods, and which suffer no deterioration in texture such as that produced by iron printing methods, are attracting much attention.

In the case of direct printing methods, for reasons including the fact that inkjet recording inks are of low viscosity and penetrate readily, the fact that the hiding power is inferior in the case of pigment inks due to the small pigment particle size (generally not more than 300 nm), and the fact that the amount of ink applied is small, the image of a printed textile item tends to be affected by the base color of the fabric, and printing onto dark-colored fabrics such as black or navy blue fabrics has proven problematic.

In order to address this issue, discharge printing-type direct inkjet textile printing methods are being developed in which a discharge ink is printed onto the fabric prior to printing, and the desired color ink printing is then performed. However, because the state of the discharge varies depending on the type of fabric, quality stability is problematic. Moreover, completely removing the dye from the fabric is difficult, meaning obtaining vivid coloration is problematic.

Another issue that is unique to printing onto fibrous products is the requirement that images printed onto fabrics used for clothing or the like must exhibit high levels of washing durability and friction durability.

In those cases where a pigment is used as the colorant, advantages include a high degree of lightfastness, favorable compatibility with a plurality of fiber types and the fact that a colorant removal step is unnecessary, and the simplicity provided by pigments is very attractive. In order to fix the pigment, a binder component must be added to the ink. However, in the case of an inkjet ink, from the viewpoints of the discharge stability, and the discharge properties and degree of nozzle blocking following sitting within the head, a large amount of the binder component cannot be used, and therefore the durability relative to washing and friction tends to be unsatisfactory.

Japanese Patent Laid-Open No. S61-215787 discloses an inkjet recording method that uses two liquids, wherein a reaction liquid comprising a polyvalent metal salt and an ink composition comprising a pigment and a resin emulsion are printed and adhered to a recording medium. It is disclosed that this method enables print bleeding and printing irregularities to be suppressed, and effectively prevents color bleeding. However, this method displays inadequate hiding power for printing onto dark-colored fabrics, and further improvements are also required in the washing durability and the friction durability properties.

Japanese Patent Laid-Open No. H09-207424 discloses an inkjet recording method wherein a reaction liquid comprising a polyvalent metal salt and an ink composition comprising a pigment and a resin emulsion are printed and adhered to a piece of paper that functions as the recording medium. This method has an object of providing a favorable image, but suffers from being unable to provide satisfactory durability to washing and friction.

### DISCLOSURE OF INVENTION

According to investigations conducted by the inventors of the present invention, the durability to washing and friction can generally be improved by increasing the resin emulsion concentration within the ink. However, on the other hand, because the viscosity of the ink tends to increase, the ink discharge volume decreases, and as a result, problems tend to develop in terms of the ink hiding properties, and the performance of the printer head upon standing when the printer is left standing in an unused state (namely, the performance upon sitting within the printer or the stability within the printer) also tends to deteriorate.

The present invention has an object of providing an ink for inkjet textile printing that exhibits favorable washing durability and friction durability properties, is capable of realizing favorable hiding power when used on dark-colored fabrics, and also exhibits excellent stability within the printer, as well as providing a method for producing a printed textile item that uses the ink.

A first aspect of the present invention provides an ink for inkjet textile printing comprising a pigment, a water-dispersible resin, water, and a water-soluble organic solvent, wherein the water-soluble organic solvent comprises a polyol having an SP value within a range from 10 to 15.5 (cal/cm³)^{1/2}, and the water-dispersible resin comprises a urethane resin having a glass transition point within a range from −35 to 10° C.

This ink for inkjet textile printing according to the present invention (hereafter also referred to as simply “the ink”) includes both inks in which the pigment is a white pigment (hereafter also referred to as “white ink”), and inks in which the pigment is a colored pigment other than white (hereafter also referred to as “colored ink”).

A second aspect of the present invention provides a method for producing a printed textile item, the method comprising: (1) applying a pretreatment agent comprising a polyvalent metal salt to a printing location on a fabric item, and (2) printing the ink for inkjet textile printing according to the aspect of the present invention described above using an inkjet recording method.

A third aspect of the present invention provides an ink set for inkjet textile printing, composed of a combination of a pretreatment agent comprising a polyvalent metal salt, a white ink according to the aspect of the present invention described above, and a colored ink according to the aspect of the present invention described above.

### BEST MODE FOR CARRYING OUT THE INVENTION

The ink is a composition comprising a pigment, a water-dispersible resin (a resin emulsion), water, and a water-soluble organic solvent. This ink is used in combination with a pretreatment agent (undercoat agent) comprising a polyvalent metal salt.

During printing, the ink forms a resin film (an ink film) on the surface of the fabric as a result of precipitation of the water-dispersible resin, and the properties of this film is closely associated with the hiding power, and the washing and friction durability. This precipitation of the resin occurs as a result of aggregation and fusion (cohesion) of the resin microparticles dispersed within the ink, caused by the action of the polyvalent metal salt, and the inventors of the present invention discovered that the properties of the water-soluble organic solvent contribute to the properties of the formed film.

In other words, although the water-soluble organic solvent is soluble in water, it is thought that the stronger the hydrophobic properties are for the solvent, the more readily the solvent is incorporated into the resin during aggregation of the resin microparticles, with this incorporated organic solvent increasing the aggregate volume of the resin and enabling the formation of a thicker film. It is thought that, as a result, the resin film develops an effect where it is able to fill spaces on the fabric surface, meaning the ink droplets can be retained on the fabric surface without penetrating into the interior of the fabric, and as a result, print bleeding can be prevented, and favorable coloration can be achieved. Moreover, it is thought that the greater the amount of ink retained at the fabric surface, the greater the amount of pigment retained in association with the resin, resulting in enhanced hiding power, and because the amount of resin retained at the fabric surface also increases, the film strength improves, and the washing and friction durability also tends to improve.

On the other hand, if the hydrophobic properties of the water-soluble organic solvent become too powerful, then the nozzles becomes prone to blockages when ink is introduced into the printer head and then left to sit in the head, meaning there is a possibility of causing problems of the printer head performance upon standing (stability within the printer). In other words, it is necessary to suppress any changes in the ink (solidification or thickening) following evaporation of the water within the ink, and it is believed that the SP value of the solvent contributes to the dispersion stability of the water-dispersible resin following evaporation of the water.

Moreover, from the viewpoint of the boiling point, the use of a polyol is preferred. The boiling point of the water-soluble organic solvent affects the performance of the printer head upon standing, and if the boiling point is too low, then problems may develop in terms of the head performance upon standing. In other words, it was ascertained that even if the SP value is within the predetermined range specified in the present invention, a low boiling point solvent such as a monool (such as methanol, ethanol or 1-propanol) tends to be prone to volatilization, and is undesirable from the viewpoint of the head performance upon standing.

Based on the above investigations, a feature of the present invention includes a water-soluble organic solvent that is capable of satisfying the requirements for both favorable coloration and durability, and favorable head latency, the water-soluble organic solvent comprising a polyol having an SP value within a range from 10 to 15.5 (cal/cm³)^{1/2}.

This SP value is the solubility parameter, and attempts to define the solubility in terms of the change in the cohesive energy. The cohesive energy of a liquid is equivalent to the enthalpy of vaporization, and based on the molar heat of vaporization ΔH^{v} and the molecular volume V, the solubility parameter δ can be defined using formula (I) shown below. Using this formula, the SP value can be calculated from the heat of vaporization required to vaporize 1 molar volume of the liquid.

[Mathematical Formula 1]

δ(SP value)={(ΔH^{v}−RT)/V}^{1/2} (1)

In the formula, ΔH represents the heat of vaporization, and V represents the molecular volume (see “A collection of examples of the application of solubility parameters” (mechanisms and examples of evaluating and calculating solubility), pages 52 to 54, published by Johokiko Co., Ltd., Mar. 15, 2007).

If this solvent SP value is lower than 10 (cal/cm³)^{1/2}, then although the coloration is excellent, the performance upon sitting within the printer tends to deteriorate. In contrast, if the SP value is higher than 15.5 (cal/cm³)^{1/2}, then although the latency within the printer is excellent, the coloration tends to deteriorate.

This range for the SP value is more preferably from 10.5 to 14 (cal/cm³)^{1/2}.

Specific examples of polyols that satisfy the above solubility properties and can be used favorably within the present invention include the compounds listed below (wherein the values listed in parentheses represent calculated SP values determined from the above formula (I)). Ethylene glycol (15.3 (cal/cm³)^{1/2}), diethylene glycol (11.2 (cal/cm³)^{1/2})^{1/2}), triethylene glycol (11.1 (cal/cm³)^{1/2}), 1,2-propanediol (12.9 (cal/cm³)^{1/2}), 1,3-propanediol (13.5 (cal/cm³)^{1/2}), 1,4-butanediol (11.8 (cal/cm³)^{1/2}), and 1,5-pentanediol (11.5 (cal/cm³)^{1/2}).

A plurality of these polyols may also be used in combination.

In contrast, although polyols, glycerol with an SP value of 16.7 (cal/cm³)^{1/2} and tetraethylene glycol with an SP value of 9.8 (cal/cm³)^{1/2} are unable to produce a favorable balance of the effects required of the polyol in the present invention, and are therefore undesirable.

However, these polyols for which the SP value is outside the preferred range may be used in combination with a polyol having an SP value within the preferred range.

Examples of water-soluble organic solvents that may be used in combination with the polyol having an SP value within a range from 10 to 15.5 (cal/cm³)^{1/2} include organic compounds that are liquid at room temperature and soluble in water. Examples include, besides the tetraethylene glycol and glycerol mentioned above, lower monoalcohols such as methanol, ethanol, 1-propanol, isopropanol, 1-butanol, 2-butanol, isobutanol and 2-methyl-2-propanol; acetins (such as monoacetin, diacetin and triacetin); glycol derivatives such as triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether and tetraethylene glycol diethyl ether; as well as triethanolamine, 1-methyl-2-pyrrolidone, β-thiodiglycol and sulfolane. Low molecular weight polyalkylene glycols, including polyethylene glycols with an average molecular weight within a range from 190 to 630, such as an average molecular weight of 200, 300, 400 or 600, polypropylene glycol diols with an average molecular weight within a range from 200 to 600, such as an average molecular weight of 400, and polypropylene glycol triols with an average molecular weight within a range from 250 to 800, such as an average molecular weight of 300 or 700, may also be used.

The polyol having an SP value within a range from 10 to 15.5 (cal/cm³)^{1/2} preferably represents not less than 60% by weight, more preferably not less than 80% by weight, still more preferably not less than 90% by weight, and most preferably 100% by weight, of the total weight of the water-soluble organic solvent.

From the viewpoints of viscosity regulation and the moisture retention effect, the total blend amount of the water-soluble organic solvent (including the polyol having an SP value within a range from 10 to 15.5 (cal/cm³)^{1/2}) within the ink is preferably within a range from 10 to 40% by weight.

The water-dispersible resin that functions as the pigment binder employs a urethane resin having a glass transition point (Tg) within a range from −35 to 10° C.

Based on investigations conducted by the inventors of the present invention, it is thought that the aggregate volume of the water-dispersible resin described above is affected not only by the SP value of the water-soluble organic solvent, but also to some extent by the Tg value of the water-dispersible resin. Specifically, it was ascertained that the Tg value of the water-dispersible resin had an effect on the stability within the printer and the coloration properties. As described above, because favorable coloration is related to having a large amount of resin retained on the fabric, the washing and friction durability also improves.

In other words, if the Tg value of the resin is too low, then although the stability within the printer is excellent, the coloration properties (and the durability) tend to be inferior, whereas if the Tg value is too high, then although the coloration (and the durability) is excellent, the stability within the printer tends to deteriorate. A Tg value within the range from −35 to 10° C. is preferred, as it enables the demands for both stability within the printer and favorable coloration (and durability) to be satisfied. The Tg value for the binder resin is more preferably within a range from −35 to 5° C.

In order to ensure favorable washing and friction durability on base materials that expand and contract readily such as fabrics, it is important that the resin film of the ink undergoes ready expansion and contraction, that is, exhibits favorable film elongation. For this reason, the resin is preferably a urethane resin.

Moreover, in terms of ensuring ready precipitation of the resin upon contact with the polyvalent metal salt contained within the pretreatment agent, the use of an anionic resin is preferred. Using such a resin enables the hiding power and the washing and friction durability to be improved.

In terms of ensuring ready precipitation under the action of the polyvalent metal salt when the pretreatment agent is used, the anionic groups within the anionic resin are preferably carboxyl groups.

Specific examples of urethane resins that satisfy the types of properties outlined above include some of the Superflex series manufactured by Dai-ichi Kogyo Seiyaku Co., Ltd., including Superflex 460 (Tg: −21° C.), 460S (Tg: −25° C.), 470 (Tg: −31° C.), 610 (Tg: −12° C.), 700 (Tg: 6° C.), 170 (Tg: 0° C.) and 840 (Tg: 5° C.). These products are anionic resins having a urethane structure.

These resins may be used individually, or a plurality of resins may be used in combination.

Moreover, in terms of the adhesiveness, elasticity, and washing and friction durability of the film, the film elongation of the urethane resin is preferably within a range from 300 to 1,000%, and more preferably from 400 to 850%.

In terms of the friction durability and texture of the film, the tensile strength of the urethane resin is preferably within a range from 20 to 50 N/mm², is more preferably not less than 30 N/mm², and is most preferably from 33 to 45 N/mm².

Moreover, the urethane resin preferably also exhibits an absolute value for the zeta potential (mV) of 40 or greater. By ensuring that the urethane resin has this level of zeta potential, the resin precipitates more readily upon contact with the polyvalent metal salt, enabling the hiding power and the washing and friction durability properties to be improved.

Another water-soluble resin may be used in combination with the urethane resin having a Tg value that the present invention specifies, provided the effects of the present invention are not impaired. In those cases where another resin is used in combination, the proportion of the urethane resin having a Tg value from −35 to 10° C. within the water-soluble resin is preferably not less than 50% by weight, more preferably not less than 80% by weight, and is most preferably 100% by weight.

From the viewpoint of ensuring favorable washing and friction durability and hiding power, and achieving an appropriate ink viscosity, the total amount of the water-soluble resin, including the urethane resin having a Tg value of −35 to 10° C., within the ink, reported as a weight ratio relative to a value of 1 for the pigment, is preferably within a range from 0.5 to 2.5.

The pigment may use any of the pigments typically used within this technical field. A white pigment is used for the white ink, and a colored pigment other than white is used for the colored ink.

Specific examples of the white pigment include inorganic pigments such as titanium oxide, zinc oxide, zinc sulfide, antimony oxide and zirconium oxide. Besides inorganic pigments, hollow resin microparticles and polymer microparticles may also be used.

The average particle size of the pigment is preferably within a range from 100 to 500 nm. If the average particle size of the pigment is less than 100 nm, then the hiding power tends to become inadequate, whereas if the average particle size exceeds 500 nm, the discharge stability tends to deteriorate.

Of the above pigments, in terms of hiding power, the use of titanium oxide is preferred. The average particle size of the titanium oxide is also preferably within a range from 100 to 500 nm. In those cases where titanium oxide is used, titanium oxide that has undergone a surface treatment with alumina or silica is preferably used in order to inhibit any photocatalytic action. The amount of this surface treatment preferably represents approximately 5 to 20% by weight of the pigment.

Examples of the colored pigment include organic pigments such as azo-based pigments, phthalocyanine-based pigments, dye-based pigments, condensed polycyclic pigments, nitro-based pigments, and nitroso-based pigments (such as brilliant carmine 6B, lake red C, Watchung red, disazo yellow, Hansa yellow, phthalocyanine blue, phthalocyanine green, alkali blue and aniline black); inorganic pigments, including metals such as cobalt, iron, chromium, copper, zinc, lead, titanium, vanadium, manganese and nickel, as well as metal oxides and sulfides, and organic pigments such as yellow ocher, ultramarine and iron blue pigments; and carbon blacks such as furnace carbon black, lamp black, acetylene black, and channel black.

Any one of these pigments may be used individually, or two or more different pigments may be used in combination.

The blend amount of the pigment varies depending on the type of pigment used, although in terms of factors such as ensuring the necessary coloration, the ink preferably includes approximately 1 to 30% by weight of the pigment, and a blend amount of 1 to 15% by weight is more preferred.

A conventional pigment dispersant typified by polymer dispersants and surfactants is preferably used to enable the pigment to be dispersed stably within the ink.

Examples of commercially available products that may be used as the polymer dispersant include the Solsperse series (Solsperse 20000, 27000, 41000, 41090, 43000 and 44000) manufactured by Lubrizol Japan Ltd., the Joncryl series (Joncryl 57, 60, 62, 63, 71 and 501) manufactured by Johnson Polymer, Inc., and polyvinylpyrrolidone K-30 and K-90 manufactured by Dai-ichi Kogyo Seiyaku Co., Ltd.

Examples of surfactants that can be used favorably as the polymer dispersant include anionic surfactants such as the Demol series (Demol N, RN, NL, RNL, and T-45) manufactured by Kao Corporation, and nonionic surfactants such as the Emulgen series (Emulgen A-60, A-90, A-500, B-40, L-40 and 420) manufactured by Kao Corporation.

In consideration of the interaction with the pretreatment agent comprising the polyvalent metal salt, the pigment dispersant is preferably anionic.

These pigment dispersants may also be used in combinations containing a plurality of different dispersants.

When a pigment dispersant is used, there are no particular restrictions on the blend amount of the pigment dispersant within the ink, which varies depending on the type of dispersant used, but generally, if reported as a weight ratio of the active ingredient (the solid fraction) relative to a value of 1 for the pigment, the amount of the pigment dispersant is preferably within a range from 0.005 to 0.5.

Moreover, self-dispersing pigments in which the pigment surface has been modified with hydrophilic functional groups may also be used. Examples of commercially available products include the CAB-O-JET series (CAB-O-JET 200, 300, 250C, 260M and 270C) manufactured by Cabot Corporation, and CW-1 and CW-2 manufactured by Orient Chemical Industries, Ltd.

Microencapsulated pigments in which the pigment is coated with a resin may also be used.

From the viewpoint of viscosity regulation, the amount of water included in the ink is preferably within a range from 20 to 80% by weight, and is more preferably from 30 to 70% by weight.

The ink may also include appropriate amounts of a wetting agent (moisture retention agent), surface tension regulator (surfactant), antifoaming agent, fixing agent, pH regulator, antioxidant and/or preservative, in addition to the components described above.

Polyhydric alcohols other than the polyols described above for the water-soluble organic solvent can be used as the wetting agent. Anionic surfactants, cationic surfactants, amphoteric surfactants, nonionic surfactants, or polymer-based, silicone-based or fluorine-based surfactants can be used as the surface tension regulator.

Including a surfactant is preferable, as it enables the ink to be discharged stably using an inkjet method, and also enables the penetrability of the ink to be appropriately controlled. The amount added varies depending on the type of surfactant used, but is preferably within a range from 0.1 to 10% by weight of the ink. If the surfactant is added in a large amount exceeding this range, then the surface tension of the ink decreases, and as a result, there is a possibility that the ink penetration into the fabric may become overly fast, hindering the hiding power and coloration properties.

Specific examples of the anionic surfactant include the Emal series (Emal 0, 10, 2F, 40 and 20C), the Neopelex series (Neopelex GS, G-15, G-25 and G-65), the Pelex series (Pelex OT-P, TR, CS, TA, SS-L and SS-H), and the Demol series (Demol N, NL, RN and MS), all manufactured by Kao Corporation.

Specific examples of the cationic surfactant include the Acetamin series (Acetamin 24 and 86), the Quartamin series (Quartamin 24P, 86P, 60W and 86W), and the Sanisol series (Sanisol C and B-50), all manufactured by Kao Corporation.

Specific examples of the nonionic surfactant include acetylene glycol-based surfactants such as the Surfynol series (Surfynol 104E, 104H, 420, 440, 465 and 485) manufactured by Air Products and Chemicals, Inc., and polyoxyethylene alkyl ether-based surfactants such as the Emulgen series (Emulgen 102KG, 103, 104P, 105, 106, 108, 120, 147, 150, 220, 350, 404, 420, 705, 707, 709, 1108, 4085 and 2025G) manufactured by Kao Corporation.

Specific examples of the amphoteric surfactant include the Amphitol series (Amphitol 20BS, 24B, 86B, 20YB and 20N) manufactured by Kao Corporation.

An electrolyte may also be added to the ink to regulate the viscosity or the pH of the ink. Examples of the electrolyte include sodium sulfate, potassium hydrogen phosphate, sodium citrate, potassium tartrate and sodium borate, and two or more of these electrolytes may also be used in combination. Compounds such as sulfuric acid, nitric acid, acetic acid, sodium hydroxide, potassium hydroxide, ammonium hydroxide and triethanolamine may also be used as either ink thickening assistants or pH regulators.

By adding an antioxidant to the ink, oxidation of the ink components can be prevented, enabling the storage stability of the ink to be improved. Examples of compounds that may be used as the antioxidant include L-ascorbic acid, sodium L-ascorbate, sodium isoascorbate, potassium sulfite, sodium sulfite, sodium thiosulfate, sodium dithionite and sodium pyrosulfite.

By adding a preservative, decomposition of the ink can be prevented and the storage stability of the ink can be improved. Examples of compounds that may be used as the preservative include isothiazolone-based preservatives such as 5-chloro-2-methyl-4-isothiazolin-3-one, 2-methyl-4-isothiazolin-3-one, 2-n-octyl-4-isothiazolin-3-one and 1,2-benzisothiazolin-3-one; triazine-based preservatives such as hexahydro-1,3,5-tris(2-hydroxyethyl)-s-triazine; pyridine-based and quinoline-based preservatives such as sodium 2-pyridinethiol 1-oxide and 8-oxyquinoline; dithiocarbamate-based preservatives such as sodium dimethyldithiocarbamate; organobromine-based preservatives such as 2,2-dibromo-3-nitrilopropionamide, 2-bromo-2-nitro-1,3-propanediol, 2,2-dibromo-2-nitroethanol and 1,2-dibromo-2,4-dicyanobutane; as well as methyl p-hydroxybenzoate, ethyl p-hydroxybenzoate, potassium sorbate, sodium dehydroacetate and salicylic acid.

The surface tension of the ink comprising the aforementioned essential components and any of the above optional components as required is preferably within a range from 30 to 50 mN/m. In order to control the ink penetration, it is necessary to control the surface tension of the ink in order to regulate the speed at which the ink penetrates into the fabric. If the surface tension of the ink is less than 30 mN/m, then the ink penetration speed increases, and an ink film cannot be formed satisfactorily on the fabric surface. Moreover, in the case of an ink having a low surface tension, the fabric tends to more readily absorb and allow penetration of the ink, meaning the pigment tends to penetrate into the interior of the fabric fibers, making it impossible to hide the color of the base fabric. On the other hand, an ink surface tension that is greater than 50 mN/m is also undesirable, as it causes a deterioration in the discharge properties from the inkjet nozzles.

The ink viscosity may be adjusted as appropriate, although from the viewpoint of the discharge properties, is preferably within a range from 1 to 30 mPa·s, and more preferably from 1.5 to 10 mPa·s. This viscosity is measured at 23° C. by raising the shear stress from 0 Pa at a rate of 0.1 Pals, and refers to the ink viscosity at 10 Pa.

Next is a description of a method for producing a printed textile item using the ink according to the present invention. This method for producing a printed textile item uses the aforementioned ink according to the present invention, and by using this ink in combination with a pretreatment agent comprising a polyvalent metal salt, the polyvalent metal salt yields effects that cause aggregation of the pigment within the ink and precipitation of the water-dispersible resin. It is thought that by precipitating the resin on the fabric surface to fill any fine holes with the fabric fibers, and increasing the size of the pigment particles, penetration of the ink can be suppressed, meaning a resin film containing the pigment particles can be formed on the fabric surface, thereby enabling the hiding power, the coloration properties, and the washing and friction durability to be improved.

Examples of the fabric include fabrics formed from various natural or synthetic fibers such as cotton, silk, wool, hemp, Nylon, polyester or rayon. The ink according to the present invention is able to produce a printed textile item that exhibits superior durability and hiding power on any of a variety of fabric materials.

The ink is used in combination with a pretreatment agent comprising a polyvalent metal salt, and the fabric is treated in advance with the pretreatment agent before being printed with the ink. In other words, the method for producing a printed textile item comprises: (1) applying a pretreatment agent comprising a polyvalent metal salt to a printing location on the fabric, and (2) printing the ink according to the present invention using an inkjet recording method. By using this production method, a printed textile item having superior coloration and hiding power can be obtained, even on dark-colored fabrics.

The polyvalent metal salt within the pretreatment agent has an action that causes aggregation of the pigment within the ink and precipitation of the resin emulsion, thus causing an ink film to be formed on the fabric.

The polyvalent metal salt comprises a divalent or higher polyvalent metal ion and an anion. Examples of the divalent or higher polyvalent metal ion include Ca²⁺, Mg²⁺, Cu²⁺, Ni²⁺, Zn²⁺ and Ba²⁺. Examples of the anion include Cl⁻, NO₃⁻, CH₃COO⁻, I⁻, Br⁻ and ClO₃⁻. Specific examples of the salt include calcium nitrate, magnesium nitrate, copper nitrate, calcium acetate and magnesium acetate.

These metal salts may be used individually, or a plurality of different salts may be used in a mixture.

From the viewpoint of enabling satisfactory formation of an ink film, the concentration of the polyvalent metal salt within the pretreatment agent is preferably within a range from approximately 1 to 13% by weight, and more preferably from 7 to 13% by weight. Although the coloration properties tend to improve with increasing blend amounts of the polyvalent metal salt, if the blend amount is too large, then the fabric may suffer from discoloration during the heat treatment conducted following printing. Accordingly, provided satisfactory coloration properties can be ensured, the blend amount of the polyvalent metal salt is preferably kept as small as possible, and the inventors discovered that when combined with the ink of the present invention, favorable coloration properties could be obtained even if the blend amount of the polyvalent metal salt was reduced below conventional blend amounts.

A water-dispersible resin (a resin emulsion) may be added to the pretreatment agent for the purposes of improving the durability and suppressing fuzzing of the fabric.

In such cases, in terms of ensuring favorable stability with the co-existent polyvalent metal salt, the water-dispersible resin preferably has an absolute value for the zeta potential (mV) of less than 10. Examples of this type of resin, in the case of urethane resins, include Superflex 500, 6E-2000, E-2500, E-4000 and R-5000 from the Superflex series manufactured by Dai-ichi Kogyo Seiyaku Co., Ltd., and Adeka Bontighter HUX-822 and 830 from the Adeka Bontighter series manufactured by Adeka Corporation. Examples of vinyl acetate resins include Vinyblan 1245L, 2680, 2682 and 2684 manufactured by Nissin Chemical Industry Co., Ltd. Examples of acrylic resins include Voncoat AN-402, R-3310 and R-3360 manufactured by DIC Corporation.

Any of the above water-dispersible resins may be used individually, or a plurality of different resins may be used in combination.

The amount of the water-dispersible resin added to the pretreatment agent is preferably within a range from 1 to 20% by weight in order to ensure that the effects of the resin manifest satisfactorily. If a large amount exceeding 20% by weight is added, then removing the pretreatment agent adhered to non-printed portions by washing becomes difficult, and there is a possibility that the commercial value of the resulting printed textile item may deteriorate.

The pretreatment agent is an aqueous solution that comprises water, but from the viewpoints of viscosity regulation and the moisture retention effect, a water-soluble organic solvent may also be added. Examples of the types of water-soluble organic solvent that may be used in the pretreatment agent include the same water-soluble organic solvents as those added to the ink described above.

The pretreatment agent may also include the types of additives typically added to inks, including preservatives, viscosity regulators, antioxidants and surfactants.

The surface tension of the pretreatment agent is preferably within a range from 40 to 70 mN/m. If the surface tension of the pretreatment agent is less than 40 mN/m, then the polyvalent metal salt within the pretreatment agent penetrates rapidly into the fabric interior, and there is a possibility that the action of the pretreatment agent on the ink may be inadequate. Moreover, when the ink is then adhered to the fabric, the pretreatment agent tends to cause a reduction in the surface tension of the ink, thereby promoting an undesirable penetration of the ink into the fabric.

There are no particular restrictions on the method used for applying the pretreatment agent in the above step (1), and an arbitrary method such as a spraying method, dipping method, padding method or coating method may be used. An inkjet recording method or screen printing method may also be used.

The pretreatment agent is applied to at least the location on the fabric that is to be printed. The pretreatment agent may also be applied to the entire fabric including the location to be printed.

Following the pretreatment of step (1), the printing step (2) of printing the ink using an inkjet recording method is conducted. The inkjet printer may employ any of various printing systems, including a piezo system, electrostatic system or thermal system, and discharges liquid droplets of the ink from the inkjet head based on a digital signal, and adheres the discharged ink droplets to the fabric that has been coated with the pretreatment agent.

When printing is performed on a dark-colored fabric, the printing step preferably includes a step (2-1) that uses a white ink, followed by a step (2-2) that uses a colored ink. This enables a more vivid image to be printed.

The fabric is preferably subjected to a heat treatment at approximately 100 to 180° C. following both the application of the pretreatment agent in step (1) and following the printing of step (2). The heat treatment following step (1) is used for drying the water within the pretreatment agent, meaning that when the ink is subsequently applied, water within the pretreatment agent is prevented from mixing with the ink and causing image bleeding, and fuzzing of the fabric surface can be remedied. The heat treatment following step (2) dries the ink and causes the water-dispersible resin to form a film, enabling a strong ink film to be formed. In those cases where step (2) is split into steps (2-1) and (2-2), the heat treatment need only be conducted after step (2-2), and there is no need to conduct a heat treatment between steps (2-1) and (2-2).

There are no particular restrictions on the treatment time, and for example, for the heat treatment following step (1), a treatment at 160° C. for approximately 10 seconds is sufficient, while for the heat treatment following step (2), a treatment at 160° C. for approximately 60 seconds is generally sufficient.

The ink according to the present invention comprises a specific resin as a binder for fixing the pigment to the fabric, and comprises a solvent having a specific solubility parameter (SP value) as the water-soluble organic solvent. As a result, favorable coloration properties and favorable washing and friction durability can be achieved while retaining excellent ink latency and discharge volume.

The method for producing a printed textile item according to the present invention uses the above ink according to the present invention, and combines this ink with a pretreatment agent comprising a polyvalent metal salt, wherein the polyvalent metal salt has the effects of causing aggregation of the pigment within the ink and precipitation of the resin. As a result, the hiding power on fabrics, the washing durability, and the friction durability can be improved.

An ink set for inkjet textile printing according to the present invention comprises a combination of the aforementioned pretreatment agent comprising a polyvalent metal salt, a white ink, and a colored ink. By using this set, a printed image can be produced that exhibits excellent coloration, hiding power, and washing and friction durability, even on dark-colored fabrics.

### EXAMPLES

A more detailed description of the present invention is presented below based on a series of examples, although the present invention is in no way limited by these examples. In the following description, the units “% by weight” are recorded as “%”, and the units “parts by weight” are recorded as “parts”.

The methods used for measuring the various properties are described below.

### <Preparation of Pretreatment Agent>

10 g of calcium nitrate tetrahydrate, 25 g of Vinyblan 1245L manufactured by Nissin Chemical Industry Co., Ltd. (zeta potential: −5.8 mV, solid fraction: 40%), and 65 g of ion-exchanged water were mixed, and the mixture was then passed through a metal mesh with a pore size of 20 μm to remove any foreign matter, thus yielding a pretreatment agent. The static surface tension of the thus obtained pretreatment agent was 40.8 mN/m.

The zeta potential of the Vinyblan 1245L was measured by diluting the Vinyblan 1245L with ion-exchanged water to obtain a solid fraction concentration of 0.1%, and then measuring the zeta potential using a zeta potentiometer “Zetasizer Nano Z” manufactured by Malvern Instruments Ltd. The surface tension values for the pretreatment agent and the white ink described below were measured using a plate-type surface tensiometer “model CBVP-Z” manufactured by Kyowa Interface Science Co., Ltd.

### <Preparation of White Pigment Dispersion>

Using 250 g of titanium oxide “R62N” (manufactured by Sakai Chemical Industry Co., Ltd.) as a white pigment, and 10 g (active ingredient: 2.5 g) of “Demol EP” (manufactured by Kao Corporation) as a pigment dispersant, these components were mixed with 740 g of ion-exchanged water, and the resulting mixture was dispersed using a beads mill (model: DYNO-MILL KDL A, manufactured by Shinmaru Enterprises Corporation), under conditions including a 0.5 mmφ zirconia beads packing rate of 80% and a residence time of 2 minutes, thus yielding a white pigment dispersion (pigment fraction: 25%). Table 1 lists the blend amount of the white pigment dispersion including the water and the pigment dispersant.

### <Preparation of White Ink>

Each of the sets of components shown in Table 1 was mixed, and any coarse particles were removed using a 5 μm membrane filter, thus completing preparation of white inks of the examples and comparative examples. The surfactant used was “Surfynol 465” manufactured by Air Products and Chemicals, Inc., and the water-soluble organic solvents were reagent grade solvents manufactured by Wako Pure Chemical Industries, Ltd. The viscosity of each of the prepared inks was within a range from 4 to 8 mPa·s (wherein the viscosity represents the viscosity at 10 Pa when the shear stress was raised from 0 Pa at a rate of 0.1 Pals at a temperature of 23° C., and was measured using a controlled stress rheometer RS75 manufactured by Haake GmbH (cone angle: 1°, diameter: 60 mm)). The surface tension of each of the prepared inks was within a range from 30 to 40 mN/m.

TABLE 1

| | | | Example | | | | | Comparative example | | | |
|---|---|---|---|---|---|---|---|---|---|---|---|
| | | | 1 | 2 | 3 | 4 | 5 | 1 | 2 | 3 | 4 |
| White ink | Water- | SF460 (solid fraction: | 26.3 | 26.3 | 26.3 | | | 26.3 | 26.3 | | |
| formulation | dispersible | 38% by weight) | | | | | | | | | |
| (parts by | resin | SF840 (solid fraction: | | | | 37 | | | | | |
| weight | | 27% by weight) | | | | | | | | | |
| | | SF470 (solid fraction: | | | | | 26.3 | | | | |
| | | 38% by weight) | | | | | | | | | |
| | | SF150 (solid fraction: | | | | | | | | 33.3 | |
| | | 30% by weight) | | | | | | | | | |
| | | SF300 (solid fraction: | | | | | | | | | 33.3 |
| | | 30% by weight) | | | | | | | | | |
| | White pigment dispersion | | 40 | 40 | 40 | 40 | 40 | 40 | 40 | 40 | 40 |
| | Surfactant | | 1 | 1 | 1 | 1 | 1 | 1 | 1 | 1 | 1 |
| | Water- | 1,3-propanediol (13.5) | 20 | | | 20 | 20 | | | 20 | 20 |
| | soluble | Diethylene glycol (11.2) | | 20 | | | | | | | |
| | organic | Triethylene glycol (11.1) | | | 20 | | | | | | |
| | solvent | Glycerol (16.5) | | | | | | 20 | | | |
| | (*SP value in | Tetraethylene glycol (9.8) | | | | | | | 20 | | |
| | brackets) | | | | | | | | | | |

| | Ion-exchanged water | 12.7 | 12.7 | 12.7 | 2 | 12.7 | 12.7 | 12.7 | 5.7 | 5.7 |
|---|---|---|---|---|---|---|---|---|---|---|
| | Total | 100 | 100 | 100 | 100 | 100 | 100 | 100 | 100 | 100 |
| Printed | Coloration | A | A | A | A | B | C | A | A | C |
| item | Stability within printer | A | A | B | B | A | A | C | C | A |
| evaluation | Washing durability | A | A | A | A | A | C | A | A | C |
| | Dry friction durability | A | A | A | A | A | C | A | A | C |
| | Wet friction durability | A | A | A | A | A | C | A | A | C |

The water-dispersible resins listed in the table refer to the following resins manufactured by Dai-ichi Kogyo Seiyaku Co., Ltd. (wherein the blend amounts in the table do not represent solid fraction amounts, but rather the blend amount of the product including water).

SF460: Superflex 460 (Tg: −21° C.)

SF840: Superflex 840 (Tg: 5° C.)

SF470: Superflex 470 (Tg: −31° C.)

SF150: Superflex 150 (Tg: 40° C.)

SF300: Superflex 300 (Tg: −39° C.)

Using each of the prepared inks and the pretreatment agent, printing was conducted in the manner described below.

Using a black 100% cotton T-shirt as the fabric, an amount of the pretreatment agent equivalent to 7 to 8 g per A3 area (297 mm×420 mm) of the fabric was applied uniformly to the T-shirt using an air brush. Following application, a heat treatment was performed at 160° C. for 10 seconds.

Subsequently, the ink of the example or comparative example was placed in a textile printer MMP813BT manufactured by Mastermind Co., Ltd., solid printing of 90 mm×90 mm was conducted at 1440 dpi×1440 dpi, and a heat treatment was then performed at 160° C. for 1 minute.

Evaluations of the printed textile items were performed in the manner described below.

### <Coloration (OD Value)>

The OD value of the printed surface was measured using a Macbeth reflection densitometer RD920.

The criteria used for evaluating the white printed items are listed below, and an evaluation of B or better was considered to indicate a practically usable level.

A: less than 0.15

B: 0.15 to 0.24

C, 0.25 or greater

<Stability within the Printer>

Each ink was loaded into the textile printer MMP813BT manufactured by Mastermind Co., Ltd., and then left to sit for one month at room temperature. Subsequently, an evaluation was performed to ascertain whether nozzle blockages that had developed within the print head could be rectified using the nozzle cleaning operation.

A: blockages rectified after 1 to 2 cleaning operations

B: blockages rectified after 3 to 4 cleaning operations

C: either rectifying the blockages required 5 or more cleaning operations, or the blockages were unable to be rectified

### <Washing Durability>

Using a fully automatic washing machine ASW-45A1 manufactured by Sanyo Electric Co., Ltd., each printed textile item was washed 10 times, and the degree of color fading was evaluated using a discoloration gray scale.

A: level 5

B: level 4 to level 4-5

C: level 3-4 to level 4

D: level 3 or lower

### <Friction Durability>

Using the methods prescribed in JIS L0849, a type I tester was used to perform the tests. The dry friction durability was tested in accordance with the dry test prescribed in JIS L0849, whereas the wet friction durability was tested in accordance with the wet test prescribed in JIS L0849, and in each case, the durability was evaluated using a contamination gray scale.

A: level 4-5 to level 5

B: level 3-4 to level 4

C: level 2-3 to level 3

D: level 2 or lower

The results obtained are summarized in Table 1.

In the inks of the examples, favorable coloration and superior levels of washing durability and friction durability were obtained, and the stability of the ink within the printer was also favorable.

1. An ink for inkjet textile printing, comprising a pigment, a water-dispersible resin, water, and a water-soluble organic solvent,
wherein the water-soluble organic solvent comprises a polyol having an SP value within a range from 10 to 15.5 (cal/cm³)^{1/2}, and
the water-dispersible resin comprises a urethane resin having a glass transition point within a range from −35 to 10° C.

2. The ink for inkjet textile printing according to claim 1, wherein a proportion of the polyol within the water-soluble organic solvent is not less than 60% by weight, and a blend amount of the water-soluble organic solvent within the ink is within the range from 10 to 40% by weight.

3. The ink for inkjet textile printing according to claim 1, wherein the urethane resin is an anionic resin.

4. The ink for inkjet textile printing according to claim 1, wherein the pigment is a white pigment.

5. The ink for inkjet textile printing according to claim 1, wherein the pigment is a colored pigment other than white.

6. A method for producing a printed textile item, the method comprising:
(1) applying a pretreatment agent comprising a polyvalent metal salt to a printing location on a fabric item, and
(2) printing the ink for inkjet textile printing according to claim 1 using an inkjet recording method.

7. The method for producing a printed textile item according to claim 6, wherein step (2) comprises: (2-1) printing the ink for inkjet textile printing using an inkjet recording method wherein the pigment is a white pigment, followed by (2-2) printing the ink for inkjet textile printing using an inkjet recording method wherein the pigment is a colored pigment other than white.

8. The method for producing a printed textile item according to claim 6, wherein the pretreatment agent comprises a water-dispersible resin having an absolute value for a zeta potential (mV) of less than 10.

9. An ink set for inkjet textile printing, composed of a combination of a pretreatment agent comprising a polyvalent metal salt, the ink for inkjet textile printing according to claim 1 wherein the pigment is a white pigment, and the ink for inkjet textile printing according to claim 1 wherein the pigment is a colored pigment other than white.
